(19) United States
(12) Patent Application Publication
(10) Pub. No.: US 2025/0038446 A1
(43) Pub. Date: Jan. 30, 2025

(54) HIGHLY STABLE GOLD FINGER WIRE END CONNECTOR

(71) Applicant: Huizhou Sanchuang Technology Co., Ltd., Huizhou (CN)

(72) Inventor: Helen Huang, Ruian (CN)

(21) Appl. No.: 18/494,694

(22) Filed: Oct. 25, 2023

(30) Foreign Application Priority Data
Jul. 27, 2023 (CN) 202321997950.7

(51) Int. Cl. H01R 13/405; H01R 12/72; H01R 12/75

(52) U.S. Cl. CPC H01R 13/405; H01R 12/721; H01R 12/75

(57) ABSTRACT

The present invention relates to the technical field of connectors, in particular to a highly stable gold finger wire end connector. The connector includes a shell, at least one set of U-shaped contact leaf springs, and a wiring board, where the U-shaped contact leaf spring has a backstop structure and a contact structure, and the backstop structure is embedded in the shell and has no less than one protrusion. The backstop structure is specially arranged for fixing, and the contact structure is arranged for contact. The independent backstop structure for fixing reduces the impact from an axial force, which does not affect the leaf spring height of the other side during assembly, effectively prevents the U-shaped contact leaf spring from loosening, improves the stability of the connector, and ensures the service life and quality of the product.

### CROSS-REFERENCE TO RELATED APPLICATIONS

This application claims priority of Chinese Patent Application No. 202321997950.7, filed on Jul. 27, 2023, the entire contents of which are incorporated herein by reference.

### TECHNICAL FIELD

The present invention relates to the technical field of connectors, in particular to a highly stable gold finger wire end connector.

### BACKGROUND

Gold finger connectors currently on the market are “I”-type leaf springs, which are prone to loosening under the action of force during insertion and pullout, thus affecting the electrical performance. Because leaf spring contact points and a backstop structure are arranged together, and also the leaf springs are affected by piercing plastic of the backstop structure during assembly, the contact point height or spring height is unstable, thus affecting the electrical performance.

### SUMMARY

On this basis, it is necessary to provide a highly stable gold finger wire end connector to solve the problems that a backstop structure of a leaf spring is easily loosened or spring height is unstable, and to develop a U-shaped contact leaf spring to separate the backstop structure out. The structure is capable to minimize the impact of leaf spring insertion/pullout and assembly on electrical performance.

To achieve the objective described above, the present invention provides the technical solution as follows: a highly stable gold finger wire end connector, including a shell, at least one set of U-shaped contact leaf springs embedded in the shell and contacted with a gold finger PCB board, and a wiring board connected to one end of the U-shaped contact leaf spring, where the U-shaped contact leaf spring has a backstop structure and a contact structure, and the backstop structure is embedded in the shell and has no less than one protrusion.

Preferably, the backstop structure includes an embedded part and a first connecting part, with a protrusion part arranged on the upper end surface of the embedded part, where the first connecting part is connected to a contact structure.

Preferably, the contact structure includes a contact part and a second connecting part connected to the first connecting part. After the first connecting part is connected to the second connecting part, a U-shaped groove is formed between the embedded part and the contact part, and the inner side of a shell is embedded in the U-shaped groove.

Preferably, the embedded part is inclined at a certain angle towards the outer side of the U-shaped groove.

Preferably, the contact part is inclined at a certain angle towards the outer side of the U-shaped groove, and a contact protrusion is formed at a tail end of the contact part.

Preferably, the protrusion part has a first inclined plane and a second inclined plane, where the first inclined plane extends along the direction in which the embedded part is inserted into the shell, the second inclined plane is located on the opposite side of the first inclined plane, and the angle of the first inclined plane is smaller than that of the second inclined plane.

Preferably, a protective body is further included.

Preferably, the protective body is injection-molded onto the shell, and the shell and the protective body wrap U-shaped contact leaf springs and a wiring board.

The present invention further provides a double-layer gold finger wire end connector including two highly stable gold finger wire end connectors connected in series. The protective body is injection-molded onto two shells, and the U-shaped contact leaf springs inside the two shells are respectively connected to the wiring board.

Beneficial effects of the present invention: the U-shaped contact leaf spring is arranged to have the backstop structure and the contact structure, where the backstop structure is specially arranged for fixing, and the contact structure is arranged for contact. The independent backstop structure for fixing reduces the impact from an axial force, which does not affect the leaf spring height of the other side during assembly, effectively prevents the U-shaped contact leaf spring from loosening, improves the stability of the connector, and ensures the service life and quality of the product.

### BRIEF DESCRIPTION OF THE DRAWINGS

FIG. 1 is a schematic diagram of the structure of an embodiment of the present invention;

FIG. 2 is a schematic diagram of the structure of assembly of a shell and U-shaped contact leaf springs in the present invention;

FIG. 3 is a schematic diagram of the structure of the U-shaped contact leaf springs in the present invention; and

FIG. 4 is a schematic diagram of the structure of another embodiment of the present invention.

### DETAILED DESCRIPTION OF THE EMBODIMENTS

With the development of electronic technology, computing and processing speeds of electronic computing devices such as computers and servers are constantly improved, to meet the people's increasing demand for data processing and computing. However, along with the evolution of processing and computing efficiency, the quantity of residual heat (waste heat) generated from the hardware is also increasing constantly. Accumulation of residual heat generated during operation of electronic computing equipment will result in overtemperature, which might affect the normal operation of and even cause damage to such equipment. In order to avoid such phenomena, a heat dissipation fan needs to be mounted inside a shell for efficient heat dissipation. The heat dissipation fan is electrically connected to a motherboard mainly through a connector for signal transmission, and is hot-swappable to facilitate maintenance. Therefore, in prior art, the connector is mainly fixed on the entire set of heat dissipation fan modules. However, due to particularity of the current connection method, special connectors are required. Gold finger connectors currently on the market are “I”-type leaf springs, which are prone to loosening under the action of force during insertion and pullout, thus affecting the electrical performance. Because leaf spring contact points and a backstop structure are arranged together, and also the leaf springs are affected by piercing plastic of the backstop structure during assembly, the contact point height or spring height is unstable, thus affecting the electrical performance. To this end, it is necessary to provide a highly stable gold finger wire end connector to solve the problems that a backstop structure of a leaf spring is easily loosened or spring height is unstable, and to develop a U-shaped contact leaf spring to separate the backstop structure out. The structure is capable to minimize the impact of leaf spring insertion/pullout and assembly on electrical performance.

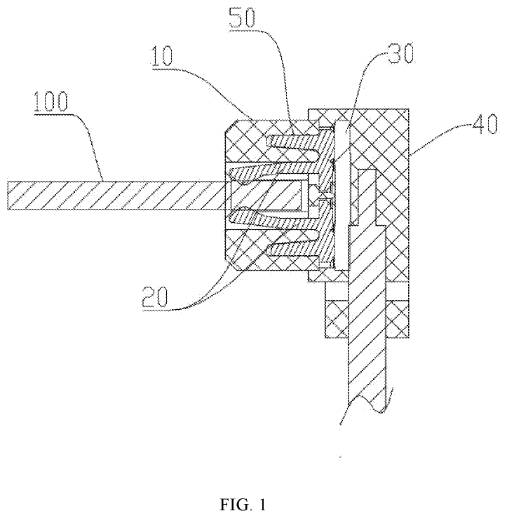

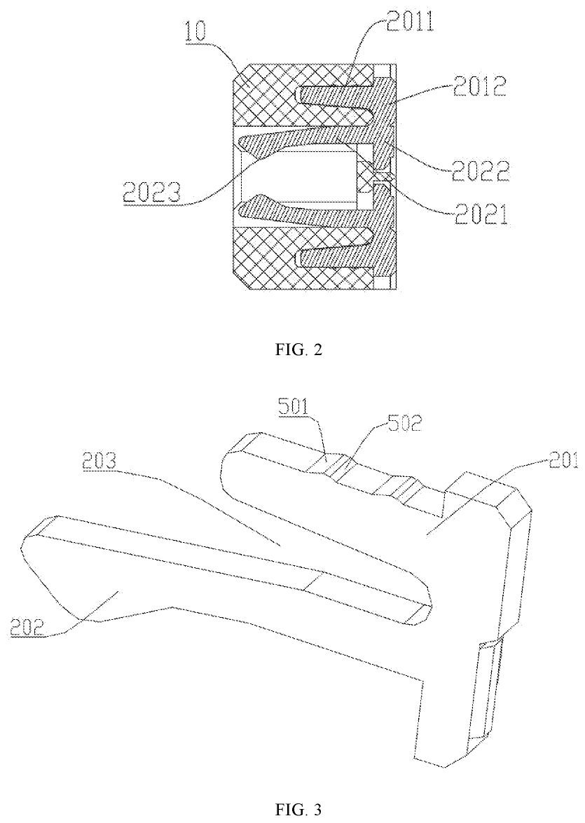

With reference to FIGS. 1, 2, and 3, in order to achieve the above objective, this embodiment provides a highly stable gold finger wire end connector, and the connector includes a shell 10, U-shaped contact leaf springs 20, a wiring board 30, and a protective body 40, where the U-shaped contact leaf spring 20 is embedded in the shell 10, one end of the U-shaped contact leaf spring 20 is welded to the wiring board 30, the wiring board 30 is configured for welding wires, the protective body 40 is injection-molded onto the shell 10 to wrap the U-shaped contact leaf spring 20 and the wiring board 30, the shell 10 is provided with an insertion connection port for inserting a gold finger PCB board 100, and the gold finger PCB board 100 is inserted into the shell 10 and contacts the U-shaped contact leaf spring 20 to achieve connection and conductivity.

In this embodiment, two sets of U-shaped contact leaf springs 20 are symmetrically arranged on the upper and lower sides of the shell 10, to facilitate conductive connection with the gold finger PCB board 100.

In order to prevent the U-shaped contact leaf spring 20 from loosening in the process of insertion connection with the gold finger PCB board 100 for multiple times so as to ensure the stability of the connection, the U-shaped contact leaf spring 20 is arranged to have a backstop structure 201 and a contact structure 202, where the backstop structure 201 is embedded in the shell 10, the contact structure 202 is located inside the insertion connection port, and the backstop structure 201 has no less than one protrusion part 50.

Specifically, the backstop structure 201 includes an embedded part 2011 and a first connecting part 2012, with a protrusion part 50 arranged on the upper end surface of the embedded part 2011, where the first connecting part 2012 is connected to the contact structure 202. The contact structure 202 includes a contact part 2021 and a second connecting part 2022 connected to the first connecting part 2012, where the first connecting part 2012 is integrated with the second connecting part 2022, and after the first connecting part 2012 is connected to the second connecting part 2022, a U-shaped groove 203 is formed between the embedded part 2011 and the contact part 2021. The inner side of the shell 10 is embedded in the U-shaped groove 203, the embedded part 2011 is inclined at a certain angle towards the outer side of the U-shaped groove 203, the contact part 2021 is inclined at a certain angle towards the other outer side of the U-shaped groove 203, and a contact protrusion 2023 is formed at a tail end of the contact part 2021. The embedded part 2011 and the contact part 2021 are obliquely arranged, and the protrusion part 50 is configured to increase friction, so as to effectively prevent the retreating of the U-shaped contact leaf spring 20 after insertion connection to the gold finger PCB board 100. In addition, the contact protrusion 2023 is arranged to facilitate contact of the U-shaped contact leaf spring 20 with the gold finger PCB board 100 for conductivity. The embedded part 2011 and the contact part 2021 are obliquely arranged, and the opening of the U-shaped groove 203 is enlarged, to facilitate installation of the U-shaped contact leaf spring 20.

Preferably, in order to facilitate installation of the U-shaped contact leaf spring 20 and prevent the U-shaped contact leaf spring 20 from retreating or loosening in the process of insertion connection with the gold finger PCB board 100, the protrusion part 50 is arranged to have a first inclined plane 501 and a second inclined plane 502, where the first inclined plane 501 extends along the direction in which the embedded part 2011 is inserted into the shell 10, the second inclined plane 502 is located on the opposite side of the first inclined plane 501, and the angle of the first inclined plane 501 is smaller than that of the second inclined plane 502, which facilitates the insertion of the U-shaped contact leaf spring 20 into the shell 10 during installation, prevents the U-shaped contact leaf spring 20 from exiting the shell 10, and can effectively embed the protrusion part 50 into the shell 10.

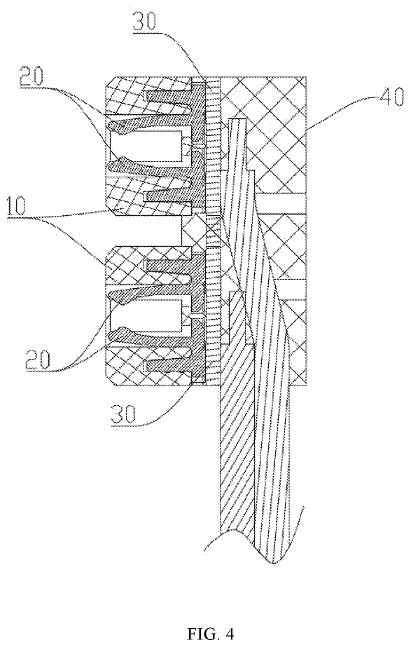

With reference to FIG. 4, this embodiment further provides a double-layer gold finger wire end connector. The connector includes two shells 10, four sets of U-shaped contact leaf springs 20 located inside the two shells 10, two wiring boards 30 welded to one end of the U-shaped contact leaf springs 20 inside the two shells 10, and a protective case injection-molded onto the two shells 10 and wraps the wiring boards 30. The double-layer gold finger wire end connector is arranged to facilitate connection with heat dissipation fans arranged in a double-layer manner, which effectively improves the connection speed.

To sum up, in the present invention, the U-shaped contact leaf spring 20 is arranged to have the backstop structure 201 and the contact structure 202, where the backstop structure 201 is specially arranged for fixing, and the contact structure 202 is arranged for contact. The independent backstop structure for fixing reduces the impact from an axial force, which does not affect the leaf spring height of the other side during assembly, effectively prevents the U-shaped contact leaf spring 20 from loosening, improves the stability of the connector, and ensures the service life and quality of the product.

In the present invention, unless otherwise explicitly specified and defined, the terms “mounting”, “connecting”, “connection”, “fixing”, etc. should be understood in a broad sense, for example, they may be a fixed connection, a detachable connection, or an integrated connection; may be a mechanical connection, or an electrical connection; may be a direct connection, or an indirect connection via an intermediate medium; and may be communication inside two elements. For those of ordinary skill in the art, the specific meanings of the terms described above in the present invention may be interpreted according to specific circumstances.

In the present invention, unless otherwise expressly stated and defined, a first feature being “above” or “below” a second feature may include the first and second features being in direct contact or that the first and second features being not in direct contact but being in contact by means of additional features between the first and second features. In addition, the first feature being “over”, “above” and “on the top of” the second feature includes that the first feature is over and above the second feature, or simply means that the level of the first feature is higher than that of the second feature. The first feature being “under”, “below” and “at the bottom of” the second feature includes that the first feature is under and below the second feature, or simply means that the level of the first feature is lower than that of the second feature.

Unless otherwise defined, technical terms or scientific terms used herein should have the usual meaning understood by those ordinarily skilled in the art to which the present invention belongs. The words “first”, “second”, and the like used in the description and claims of the application of the present invention do not indicate any order, quantity or importance, but are used only to distinguish different components. Likewise, the words “a” or “one”, and the like do not indicate any limitations on quantity, but rather indicate the presence of at least one.

The technical features of the above embodiments can be combined arbitrarily. For the sake of brevity, all possible combinations of the technical features in the above embodiments are not described. However, as long as the combinations of these technical features are not contradicted, it should be regarded as the scope of the description in this specification.

1. A highly stable gold finger wire end connector, comprising a shell, at least one set of U-shaped contact leaf springs embedded in the shell and contacted with a gold finger PCB board, and a wiring board connected to one end of the U-shaped contact leaf spring, wherein the U-shaped contact leaf spring has a backstop structure and a contact structure, and the backstop structure is embedded in the shell and has no less than one protrusion.

2. The highly stable gold finger wire end connector according to claim 1, wherein the backstop structure comprises an embedded part and a first connecting part, with a protrusion part arranged on the upper end surface of the embedded part, wherein the first connecting part is connected to a contact structure.

3. The highly stable gold finger wire end connector according to claim 2, wherein the contact structure comprises a contact part and a second connecting part connected to the first connecting part. After the first connecting part is connected to the second connecting part, a U-shaped groove is formed between the embedded part and the contact part, and the inner side of a shell is embedded in the U-shaped groove.

4. The highly stable gold finger wire end connector according to claim 3, wherein the embedded part is inclined at a certain angle towards the outer side of the U-shaped groove.

5. The highly stable gold finger wire end connector according to claim 3, wherein the contact part is inclined at a certain angle towards the outer side of the U-shaped groove, and a contact protrusion is formed at a tail end of the contact part.

6. The highly stable gold finger wire end connector according to claim 2, wherein the protrusion part has a first inclined plane and a second inclined plane, wherein the first inclined plane extends along the direction in which the embedded part is inserted into the shell, the second inclined plane is located on the opposite side of the first inclined plane, and the angle of the first inclined plane is smaller than that of the second inclined plane.

7. The highly stable gold finger wire end connector according to claim 1, wherein a protective body is further comprised.

8. The highly stable gold finger wire end connector according to claim 7, wherein the protective body is injection-molded onto the shell, and the shell and the protective body wrap U-shaped contact leaf springs and a wiring board.

9. A double-layer gold finger wire end connector, comprising two highly stable gold finger wire end connectors connected in series according to claim 1, wherein the protective body is injection-molded onto two shells, and the U-shaped contact leaf springs inside the two shells are respectively connected to the wiring board.

10. A double-layer gold finger wire end connector, comprising two highly stable gold finger wire end connectors connected in series according to claim 2, wherein the protective body is injection-molded onto two shells, and the U-shaped contact leaf springs inside the two shells are respectively connected to the wiring board.
